(19) United States
(12) Patent Application Publication
(10) Pub. No.: US 2002/0043507 A1
(43) Pub. Date: Apr. 18, 2002

(54) Debris catcher

(76) Inventor: Stephen McCulloch, Katy, TX (US)

Correspondence Address: Shawn Hunter, BRACEWELL & PATTERSON, L.L.P., P.O. Box 61389, Houston, TX, 77208-1389, US

(21) Appl. No.: 09/834,144

(22) Filed: Apr. 12, 2001

(30) Foreign Application Priority Data
Apr. 12, 2000 (GB) 0008948.2
Apr. 28, 2000 (GB) 0010268.1

(51) Int. Cl. B04B 1/00

(52) U.S. Cl. 210/788; 210/323.2; 210/512.1

(57) ABSTRACT

Devices and methods for removing debris solids from a hydrocarbon production stream A debris catcher device is associated with a production stream at the wellhead. Three debris catcher designs are described. In each, the debris catcher includes a housing that defines a first, generally cylindrical gallery having an enlarged diameter and a second, generally cylindrical gallery having a smaller diameter. The two galleries are disposed adjacent to one another. A fluid inlet and solids outlet adjoin the outer radial perimeter of the enlarged diameter gallery while a fluid outlet departs axially with respect to the enlarged diameter gallery. A lateral bore is disposed through the housing of the debris catcher in a coaxial orientation to the two galleries. In operation of each of the embodiments of the debris catchers, fluid carrying sand or other solids enters the large diameter gallery through the fluid inlet and circulates within the enlarged diameter gallery where its flow velocity is reduced. Particles are separated by gravity and fall into the solids outlet. The placement of the fluid inlet and solids outlet bore provide mechanical assistance to removal of the larger particles. Movement of the fluid within the second gallery chamber is speeded up, thereby causing removal of additional solids, primarily smaller sands. Due to differential pressure, production fluid is transmitted radially inwardly through a perforated flow cage filter and then flows through a flow enhancer that streamlines flow and dissipates pressure energy associated with the fluid flow.

### CROSS REFERENCE TO RELATED APPLICATIONS

This application claims the priority of British Provisional patent application serial no. 0008948.2 filed Apr. 12, 2000 and serial no. 0010268.1 filed Apr. 28, 2000.

### BACKGROUND OF THE INVENTION

1. Field of the Invention

The present invention relates broadly to methods and systems for separating out solid contaminants from fluids, such as hydrocarbons removed from a well. In particular aspects, the invention relates to methods and systems for treatment of a hydrocarbon production stream at the wellhead to remove solid contaminants and improve flow.

2. Description of the Related Art

Certain amounts of undesirable debris solids are present in hydrocarbons that are produced from a well. Design of a single system for removal of solids is difficult since the types of hydrocarbon fluids that are flowed from a well may range from extremely viscous liquids to very light gases. In addition, the solids take many forms including fracture pellets resulting from well stimulation activities or geological formation debris such as pebbles, sand, or gravel. General debris resulting from well drilling and control activities, such as hard baked drilling mud, may also be present. These solids are undesirable because they can harm downstream processing equipment through increased viscosity and abrasion. Compounding the problem is the fact that the debris solids exist in different concentrations that vary constantly in relation to the manner in which the hydrocarbons are flowed from the well.

Because of the downstream problems resulting from debris solids in the hydrocarbon fluids, the rate of production is often regulated to a lower flow rate at which the level of debris can be tolerated by downstream equipment. However, maintaining this low flow rate may not always be practical due to commercial demands for the hydrocarbons.

Efforts have been made to develop an acceptable system for removing sand from hydrocarbon production streams. However, those efforts have focused primarily upon the use of tapered, conical hydrocyclones, or similar devices, that essentially permit the sands to settle to the bottom of a tank while drawing the fluid off through a filter media, such as a porous screen. For example, U.S. Pat. No. 3,529,724 issued to Maciula et al. describes an arrangement for removing solid contaminate particles from a fluid medium using a hydroclone. U.S. Pat. No. 6,119,779 issued to Gipson also describes a method of separating sand from a production stream using a hydrocyclone.

There are problems associated with the prior art methods due to their use of the hydrocyclone and its filter media as the sole, or primary, means for removing solids generally from a production stream. The hydrocyclone typically is provided only with a filter media designed to remove particles of a particular size. If the filter media is designed to capture larger particles, such as pebbles, the majority of smaller particles will pass easily through the filter medai and be transmitted downstream where they will create abrasive problems. If, on the other hand, the filter media is designed to capture smaller contaminants, such as grains of sand, the filter may become clogged very quickly as larger particles are captured as well. This will require that the filter media be cleaned or replaced often. Accordingly, the production operation will be slowed as the cleaning or replacement is done.

The present invention addresses the problems associated with the prior art.

### SUMMARY OF THE INVENTION

The invention provides devices and methods for effectively removing debris solids from a hydrocarbon production stream In preferred embodiments, a debris catcher device is associated with a production stream at the wellhead. Three exemplary debris catcher designs are described. In each, the debris catcher includes a housing that defines a first, generally cylindrical gallery having an enlarged diameter and a second, generally cylindrical gallery having a smaller diameter. The two galleries are disposed adjacent to one another. A fluid inlet and solids outlet adjoin the outer radial perimeter of the enlarged diameter gallery while a fluid outlet departs axially with respect to the enlarged diameter gallery. A lateral bore is disposed through the housing of the debris catcher in a coaxial orientation to the two galleries.

One embodiment of debris catcher is described in which the fluid inlet and solids outlet each adjoin the enlarged diameter gallery in a radial direction relative to the concentric center of the gallery. A second, and more preferred embodiment is described in which the fluid inlet adjoins the gallery tangentially rather than in a radial direction while the solids outlet adjoins the gallery in a radial direction. In a third, and most highly preferred embodiment, both the fluid inlet and solids outlet adjoin the gallery tangentially. The solids outlet is located 270 degrees clockwise from the fluid inlet.

In operation of each of the embodiments of the debris catchers, fluid carrying sand or other solids enters the enlarged diameter gallery through the fluid inlet and circulates within the enlarged diameter gallery where its flow velocity is reduced. Particles are separated by gravity and fall into the solids outlet. Following removal of the larger solids in this manner, the production fluid is flowed into the adjoining second gallery chamber, which has a smaller diameter. Movement of the fluid within the second gallery chamber will be faster, thereby causing removal of additional solids, primarily smaller sands through increased centrifugal forces. Due to differential pressure, production fluid is transmitted radially inwardly through a perforated flow cage filter and then flows through a flow enhancer that streamlines flow and dissipates pressure energy associated with the fluid flow.

In certain aspects, the systems and methods of the present invention provide for staged removal of debris solids from the hydrocarbon flow. In addition, a variety of mechanisms are employed to remove such solids. The debris catcher, for example, varies the fluid flow rate to assist in debris removal. Reduction of the flow rate of the fluid permits larger contaminants to fall out of the fluid under centrifugal movement. More rapid circular movement of the fluid at a later stage increases centrifugal forces. The placement of the fluid inlet and solids outlet bores and the existence of the shoulder separating the two galleries each provide mechanical assistance for removal of the larger particles.

### BRIEF DESCRIPTION OF THE DRAWINGS

FIG. 1 is a schematic illustration of an exemplary wellhead flow management system incorporating a debris catcher device constructed in accordance with the present invention.

FIG. 2 is a side cross-sectional view of a first exemplary debris catcher device constructed in accordance with the present invention.

FIG. 3 is an exploded side sectional view of the device shown in FIG. 2.

FIG. 4 is an end-on cross-sectional view of the device shown in FIGS. 2 and 3 taken along the lines 4-4 in FIG. 2.

FIG. 5 is a side cross-sectional view of a second exemplary debris catcher device.

FIG. 6 is an end-on cross-sectional view of the device shown in FIG. 5 taken along the lines 6-6 in FIG. 5.

FIG. 7 is a side cross-sectional view of a third exemplary debris catcher device.

FIG. 8 is an end-on cross-sectional view of the device shown in FIG. 7 taken along lines 8-8 in FIG. 7.

FIG. 9 is a defined space diagram depicting the volume contained by the exemplary debris catcher shown in FIGS. 5 and 6.

FIG. 10 is a defined space diagram illustrating the volume contained by the exemplary debris catcher shown in FIGS. 7 and 8.

FIGS. 11 and 12 are charts that graphically show the percentages of particles trapped, by diameter, using each of the described embodiments of debris catchers.

### DETAILED DESCRIPTION OF THE PREFERRED EMBODIMENTS

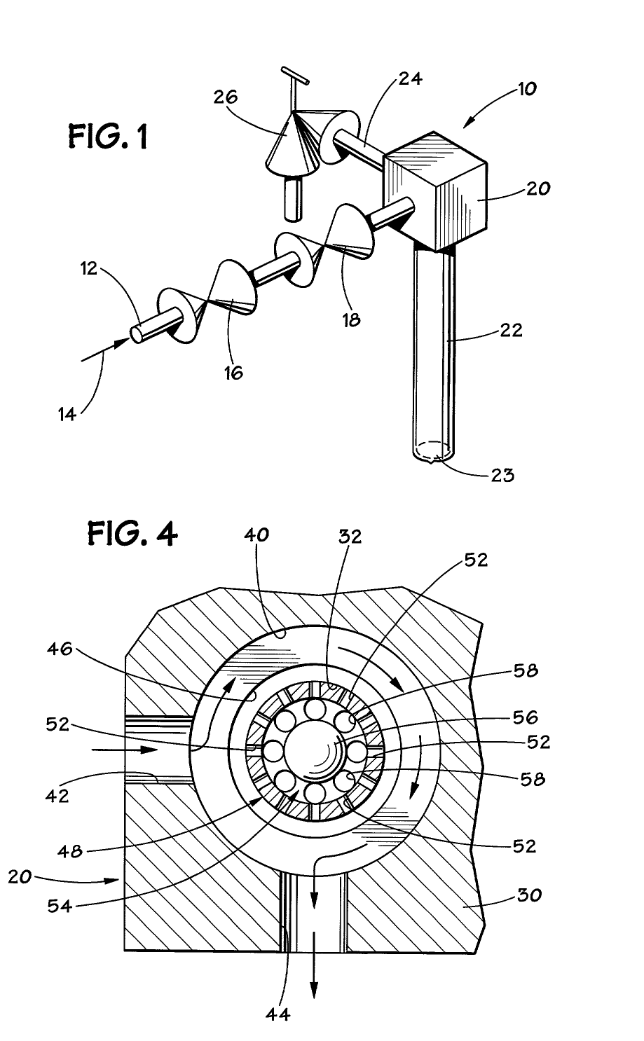

FIG. 1 depicts, in schematic fashion, a portion of a hydrocarbon production flow assembly 10 that is associated with a production wellhead (not shown) such that production fluid produced by the wellhead leaves via the flow assembly 10. The production flow assembly 10 includes a flow conduit 12 into which production fluid from the wellhead is flowed, as indicated by the arrow 14. Two wing valves 16, 18 are associated with the conduit 12. At its distal end, the flow conduit 12 enters a debris catcher device 20, the structure and operation of which will be described shortly. Affixed to the debris catcher 20 is a solids removal conduit 22 and a fluid removal conduit 24. The solids removal conduit 22 is generally tubular and may comprise a vessel designed to capture and retain solid particles that are removed from the fluid stream by the debris catcher. The solids removal conduit 22 has a closed lower end 23. When constructed for operation, the conduit 22 extends downwardly toward the ground. A choke valve 26 is associated with the fluid removal conduit 24 and used to control flow from the wellhead. Beyond the choke valve 26, the fluid removal conduit 24 continues toward downstream processing equipment (not shown).

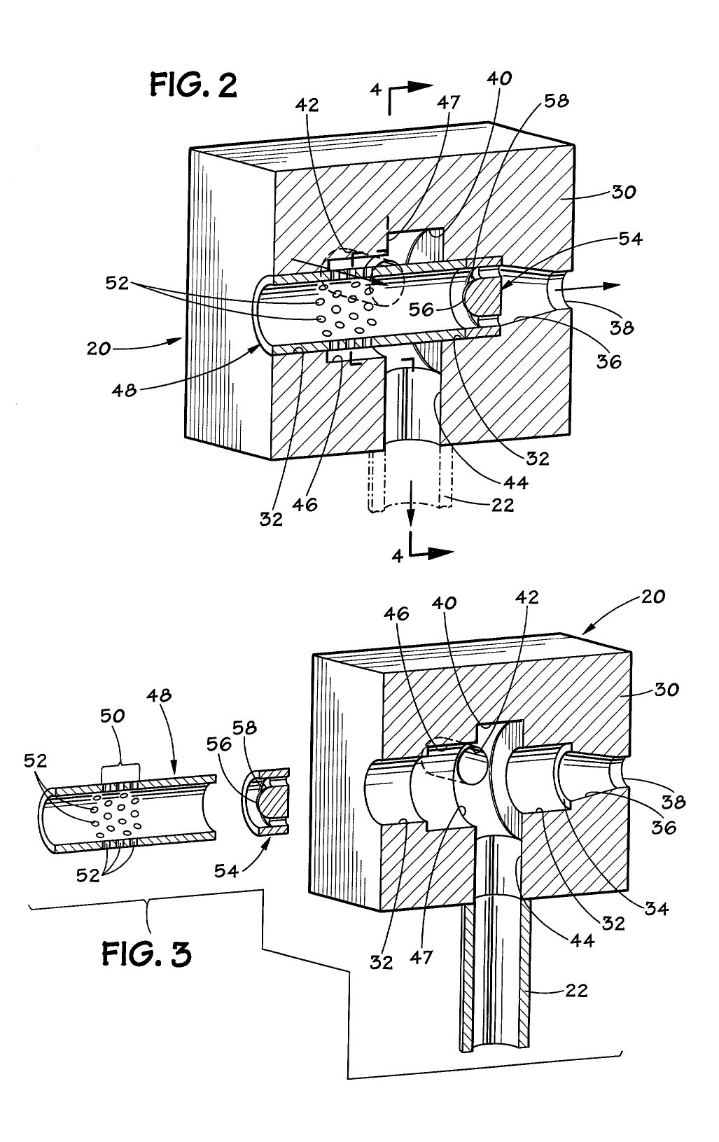

By reference to FIGS. 2, 3, and 4, the details of construction and operation for a first exemplary debris catcher device 20 may be appreciated. The debris catcher 20 includes an outer housing 30, that is shown in cross-section in FIGS. 2 and 3. Although the shape of the housing 30 is shown as a rectangular block, the housing 30 may, in fact, be of any desired shape. The housing 30 is preferably constructed from a durable metal. As best shown in FIG. 3, the housing 30 defines a lateral, cylindrical bore 32 with a stop shoulder 34 at its distal end. A tapered bore portion 36 leads from the stop shoulder 34 to a fluid outlet 38 of reduced diameter.

A enlarged diameter cylindrical chamber, or gallery, 40 is disposed along at the approximate mid-point of the cylindrical bore 32 in a coaxial relation therewith. As best shown perhaps in FIG. 4, the fluid inlet bore 42 is shown adjoining the cylindrical gallery 40 and approaching the gallery 40 in a radial direction relative to the concentric center of the gallery 40. In operation, the fluid inlet bore 42 receives hydrocarbon production fluid from the conduit 12 and transmits it into the gallery 40 under pressure. A solid particle outlet bore 44 adjoins the gallery 40 at its lowest point. The solids outlet 44 is operably associated with the solids removal conduit 22. Like the fluid inlet bore 42, the outlet bore 44 approaches the gallery 40 in a radial direction relative to the center of the gallery 40. A second cylindrical chamber, or gallery, 46 is located coaxially with and adjoining the expanded diameter gallery 40, thereby defining an annular shoulder 47. The second cylindrical chamber, or gallery, 46 has a diameter that is smaller than the diameter of the first gallery 40.

A tubular flow cage filter 48 is retained within the lateral bore 32 of the housing 30. The flow cage filter 48 has a perforated section 50 (see FIG. 3) wherein perforations 52 pass through the wall of the flow cage filter 48. When the flow cage filter 48 is retained within the lateral bore 32, the perforated section 50 is disposed radially within the reduced diameter gallery 46.

A generally cylindrical pipe choke 54 is also retained within the lateral bore 32 of the housing 30. The pipe choke 54 is of a type described in greater detail in U.S. patent application Ser. No. 09/756,425 filed Jan. 8, 2001, which is owned by the assignee of the present invention and which is incorporated herein by reference. Basically, the pipe choke 54 is a flow restrictor, or flow enhancer, that is geometrically configured to streamline the flow of fluid and dissipate energy. The pipe choke 54 comprises generally a cylindrical body having a central hub 56 with a plurality of fluid apertures 58 surrounding the hub 56.

When the debris catcher 20 is assembled for operation, as shown in FIGS. 2 and 4, production fluid carrying solids, such as sand, enters the fluid inlet 42 through the flow conduit 12 and is disposed into the first gallery 40. The flow of fluid expands radially and axially to occupy the volume defined by the enlarged diameter gallery 40. As a result of the increase in available volume, the fluid velocity is decreased. Reduction of the flow velocity initiates particle separation. Heavier solid particles fall into the solids outlet 44 under force of gravity and enter the solids removal conduit 22. The fluid will also move in a circular path around the circumference of the gallery. This circular movement of the fluid will impart some centrifugal force to solid particles within the fluid and cause them to move radially outwardly where they will eventually exit the solids outlet 44.

The fluid flow is attracted to the fluid outlet 38 due to the existence of lower, downstream, pressure there. In order to reach the fluid outlet 38, the fluid must pass through the reduced diameter gallery 46 and perforations 52 to enter the interior of the flow cage 48. Thus, the fluid flow is forced back on itself into a smaller gallery volume opposite the fluid outlet 38. As fluid enters the reduced diameter gallery 46, it is also circulated at a faster rate due to the reduction of radius of the gallery 46 as compared to the gallery 40. Thus, further particle separation is accomplished within the reduced diameter gallery 46. Additionally, the shoulder 47 physically prevents larger solid particles from entering the reduced diameter gallery 46 at all. These larger particles tend to drop out of the debris catcher 20 through the solids outlet 44. The apertures 52 further screen out those solid particles which are too large to fit through them.

Once inside the flow cage 48, production fluid is flows toward the fluid outlet 38 and passes through the flow restrictor 54. The flow restrictor 54 streamlines the flow and reduces the pressure associated with it. Fluid exiting the debris catcher device 20 has only a small percentage of small particles entrained therein. These remaining particles are generally so small that they are largely incapable of causing any damage to downstream equipment.

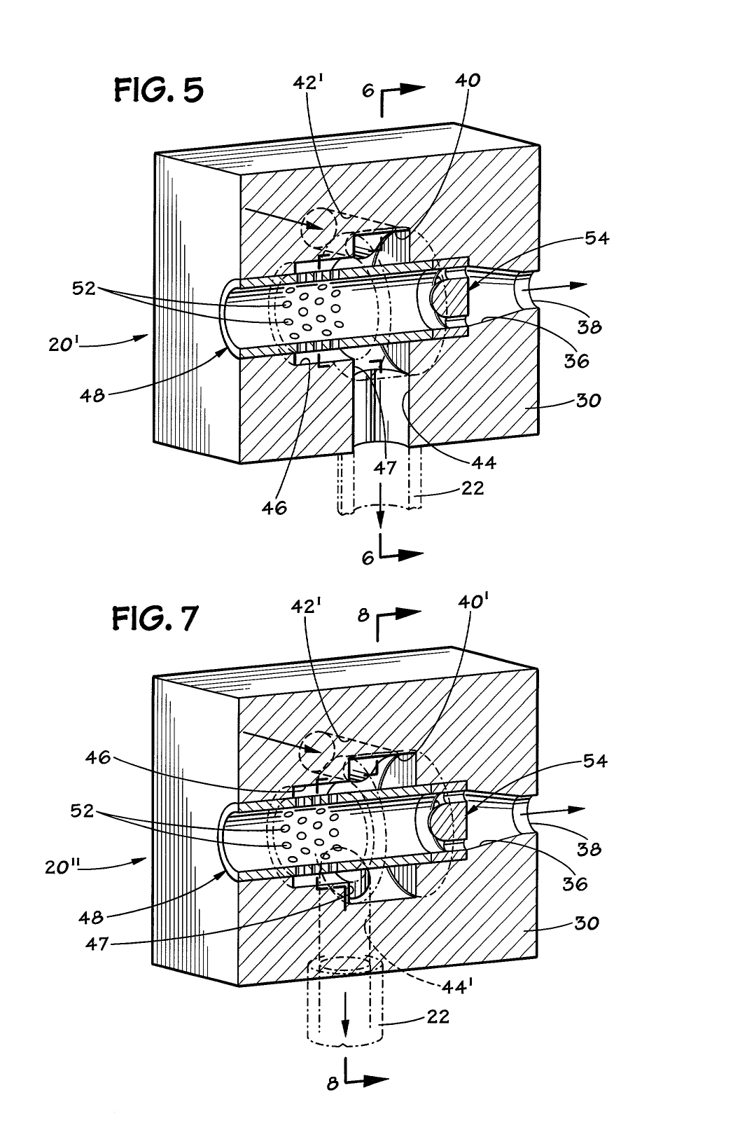

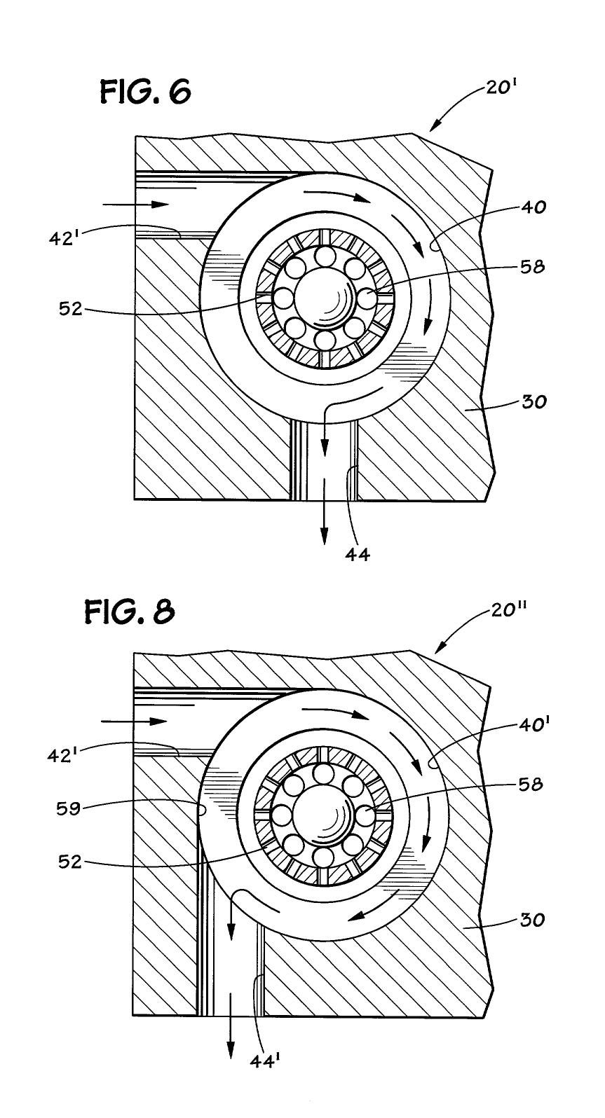

Referring now to FIGS. 5 and 6, an alternative embodiment for a debris catcher device 20′ is described. Debris catcher 20′ is similar in many respects to the debris catcher 20 described previously. For clarity, like reference numerals are used to designate like components. The debris catcher 20′ is preferred over the debris catcher 20. As best shown in FIG. 6, the solids outlet 44 adjoins the enlarged diameter gallery 40 in a radial relation thereto. The fluid inlet 42′, however, adjoins the gallery 40 tangentially with respect to the circumference of the gallery 40 rather than radially as with the debris catcher 20. As a result of this tangential relationship, fluid entering the gallery 40 through the inlet 42′ will flow more readily in a circular path. As a result, the centrifugal forces applied to the solid particles within the gallery 40 are increased.

FIGS. 7 and 8 illustrate a second alternative embodiment for a debris catcher 20″. Again, the debris catcher 20″ has many similarities in its construction and operation to the debris catchers 20 and 20′ previously described. Among the three embodiments, the debris catcher 20″ is the most highly preferred embodiment. The fluid inlet 42′ adjoins the enlarged diameter gallery 40′ tangentially. The solids outlet 44′ adjoins the gallery 40′ tangentially as well and is located 270° clockwise from the inlet 42′ around the circumference of the gallery 40′. There are particular advantages to this placement of the solids outlet 44′. Specifically, the solids-containing fluid must travel a further distance around the circumference of the gallery 40′ in order to reach the solids outlet 44′. Increased abrasive contact with the outer radial wall of the gallery 40′ will assist slowing of the solid particles and their ultimate removal from the gallery 40′. Additionally, placement of the solids outlet 44′ to tangentially adjoin the rear portion 59 of the gallery 40′—that is the portion of the gallery 40′ that lies at an approximate right angle to and closest to the fluid inlet 42′. In addition, the solids outlet 44′ adjoins the gallery 40′ 270 degrees clockwise from the fluid inlet 42′. The geometrical relationship of the solids outlet 44′ to the fluid inlet 40′ allows gravity to work to maximum advantage on the solid particles entrained within the production fluid. Because the fluid must traverse substantially the entire circumference of the gallery 40′ before reaching the solids outlet 44′, centrifugal forces and even frictional forces created by the walls of the gallery 40′ will work to slow the fluid flow and solid particles. Solid particles moving within the flow at the rear portion 59 of the gallery 40′ will be moving upwardly against gravity and are, therefore, provided additional urging to enter the outlet 44′.

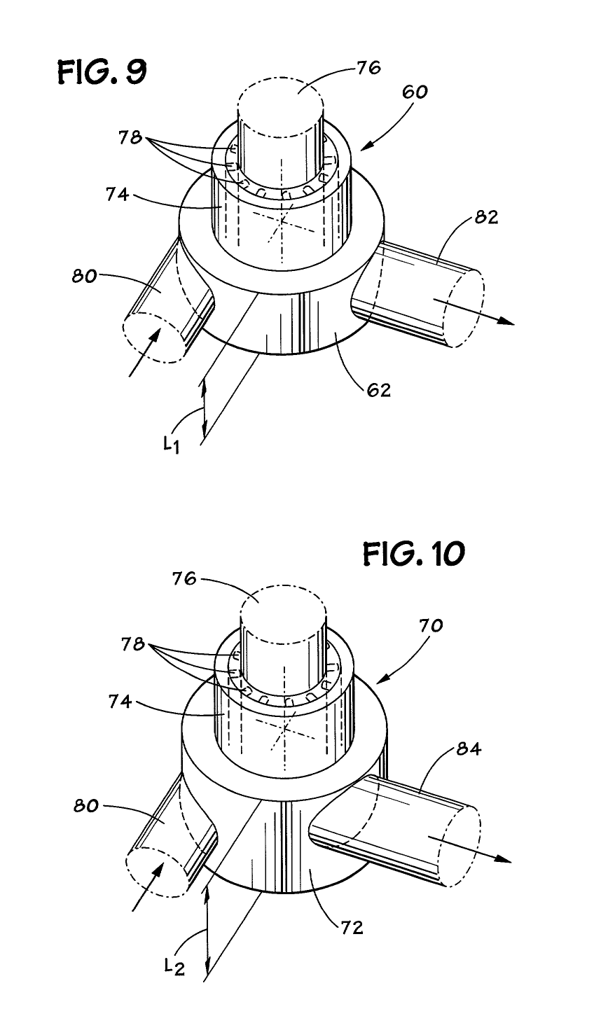

FIGS. 9 and 10 are defined space diagrams that illustrate the volumes contained within the debris catcher devices 20′ and 20″, respectively. The first volume body 60, which is depicted in FIG. 9, has a portion 62 that is representative of the volume enclosed by the gallery 40 of the debris catcher 20′. The second volume body 70, which is shown in FIG. 10, has a portion 72 that is representative of the volume enclosed by the gallery 40′ of the debris catcher 20′. Portion 74 in each drawing represents the volume enclosed by the reduced diameter gallery 46. Portion 76 in each drawing represents the volume enclosed within the flow cage 48, while portions 78 depict the volumes enclosed by the apertures 52. In each of FIGS. 9 and 10, the volume portions 80 represent the volumes enclosed by the fluid inlets 42′ of each debris catcher design 20′, 20″, while volume portions 82, 84 are the volumes defined by the solids outlets 44, 44′, respectively. As can be seen by comparison of the two drawings, the axial length “L²” of the radially enlarged gallery 40′ (corresponding to defined volume 72) is greater than the axial length “L¹” of the radially enlarged gallery 40 (corresponding to defined volume 62). In addition, as is visible in both FIGS. 7 and 10, the solids outlet 44′ (as well as its defined volume 84) is axially offset from the fluid inlet 42′ (and its defined volume 80). This is not true of the debris catchers 20 or 20′. The axial lengthening of the gallery 40′ as compared to the gallery 40, and the offsetting of the solids outlet 44′ affords the advantages of increasing the volume in which entering fluid may flow, thereby further reducing its velocity.

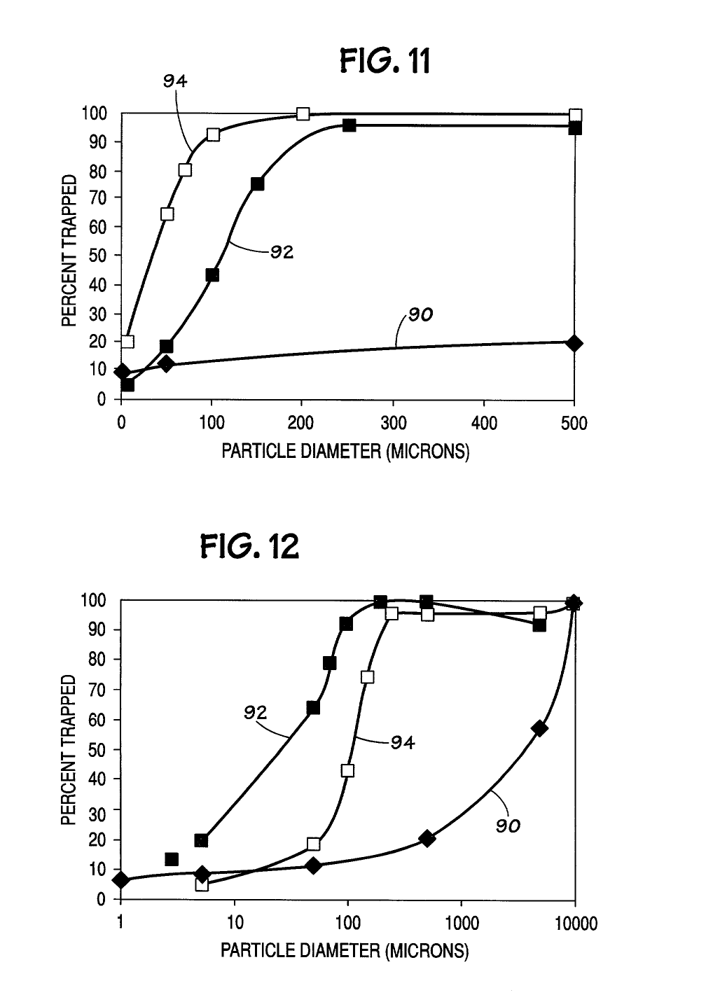

FIGS. 11 and 12 illustrate the relative effectiveness of solid particle removal as between the three embodiments of debris catchers 20, 20′ and 20″ described above. FIG. 12 views particle sizes on a somewhat larger scale than FIG. 11 since particle sizes from 1 to 10,000 microns are shown as opposed to a range of 0 to 500 microns. The graphs of FIGS. 11 and 12 show the percentages of solid particles captured using each debris catcher design 20, 20′ and 20″. Graph lines 90 in each Figure illustrate the particles captured using design 20. Graph lines 92 show the particles captured by debris catcher design 20′, while graph lines 94 depict the particles captured by debris catcher design 20″. Those of skill in the art will recognize that each of the debris catcher designs is quite effective at removing a range of solid particle sizes and that each design has proven empirically to have a particular advantage for removal of certain particle sizes.

It will be appreciated that the exemplary debris catcher devices described herein provide the benefit of extracting debris from production fluid near the wellhead before the debris can enter any downstream equipment. They also introduce a level of flow and pressure control that permits the well to flow at higher rates and help reduce downstream equipment damage.

While the invention has been described with reference to preferred embodiments, it should be apparent to those skilled in the art that it is not so limited, but is susceptible to various modifications and changes without departing from the scope of the invention.

What is claimed is:

1. A debris catcher for separating solids from a fluid stream comprising:
a first, generally cylindrical gallery chamber having a first diameter;
a fluid inlet adjoining the first gallery chamber to transmit fluid therein;
a solid debris outlet adjoining to the first gallery chamber to permit solids to exit therefrom;
a second, generally cylindrical gallery chamber located adjacent the first gallery chamber, the second gallery chamber having a second diameter that is smaller than the first diameter; and
a fluid outlet associated with the second gallery chamber to exit the second gallery chamber at a normal angle thereto.

2. The debris catcher of claim 1 further comprising a filter media disposed within the second gallery chamber for filtering solid particles from fluid.

3. The debris catcher of claim 2 wherein the filter media comprises a porous sleeve.

4. The debris catcher of claim 2 further comprising a flow restrictor device to receive fluid from the filter media.

5. The debris catcher of claim 4 wherein the flow restrictor device is located between the filter media and the fluid outlet.

6. The debris catcher of claim 1 wherein the fluid inlet adjoins the first gallery chamber radially.

7. The debris catcher of claim 1 wherein the fluid inlet adjoins the first gallery chamber tangentially.

8. The debris catcher of claim 1 wherein the solid debris outlet adjoins the first gallery chamber tangentially.

9. The debris catcher of claim 1 wherein the solid debris outlet adjoins the first gallery chamber radially.

10. A debris catcher for separating solids from a fluid production stream comprising:
a first, generally cylindrical gallery chamber having a first diameter;
a fluid inlet adjoining the first gallery chamber to transmit fluid therein;
a solid debris outlet adjoining to the first gallery chamber to permit solids to exit therefrom; and
a fluid outlet associated with the second gallery chamber to exit the second gallery chamber at a normal angle thereto.

11. The debris catcher of claim 10 further comprising a second, generally cylindrical gallery chamber located adjacent the first gallery chamber, the second gallery chamber having a second diameter that is smaller than the first diameter.

12. The debris catcher of claim 10 further comprising a filter media for filtering solid particles from fluid.

13. The debris catcher of claim 10 further comprising a flow restrictor device.

14. The debris catcher of claim 10 wherein the fluid inlet adjoins the first gallery chamber radially.

15. The debris catcher of claim 10 wherein the fluid inlet adjoins the first gallery chamber tangentially.

16. The debris catcher of claim 10 wherein the solid debris outlet adjoins the first gallery chamber tangentially.

17. The debris catcher of claim 10 wherein the solid debris outlet adjoins the first gallery chamber radially.

18. A method of separating solids from a fluid production stream comprising the steps of:
transmitting a stream of solids-contaminated production fluid through a fluid inlet into a first, first cylindrical gallery;
separating solid contaminants from the stream of production fluid by slowing the rate of fluid flow within the first gallery;
removing separated solid contaminants from the first gallery through a solids outlet; and
removing cleansed fluids from the first gallery through a fluids outlet.

19. The method of claim 18 further comprising the step of transmitting the stream of solids-contaminated production fluid from the first cylindrical gallery to a second cylindrical gallery having a smaller diameter than that of the first cylindrical gallery to speed the flow of the stream.

20. The method of claim 18 further comprising the step of disposing the stream of fluid through a filter media.
